(19) United States
(12) Patent Application Publication
(10) Pub. No.: US 2009/0183237 A1
(43) Pub. Date: Jul. 16, 2009

(54) Contextual and customized help information

(76) Inventors: Ricardo Cortes, Los Gatos, CA (US); Aji Mathai, Santa Clara, CA (US); Aloke Bhatnagar, Campbell, CA (US); David Alonzo Van Tassell, Campbell, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/034,582

(22) Filed: Feb. 20, 2008

Related U.S. Application Data
(60) Provisional application No. 61/020,717, filed on Jan. 12, 2008.

(51) Int. Cl. G06F 3/048; H04L 9/32

(52) U.S. Cl. 726/4; 715/708

(57) ABSTRACT

Improved methods, systems, computer readable media and graphical user interfaces for automated customer support are disclosed. Automated customer support can be computer-implemented and can provide help information to users. The help information can be context sensitive and/or customized. For example, the help information can be dependent on (i) context of a help request and/or (ii) a particular user. Further, if a user requires more help than the automated customer support can provide, then the user can be provided with the opportunity to contact a customer support agent for additional assistance.

### CROSS-REFERENCE TO OTHER APPLICATION

This application claims priority to U.S. Provisional Patent Application No. 61/020,717, filed Jan. 12, 2008, entitled “CONTEXTUAL AND CUSTOMIZED HELP INFORMATION”, which is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure as it appears in the U.S. Patent and Trademark Office patent file or records, but otherwise reserves all copyright rights whatsoever.

### BACKGROUND OF THE INVENTION

1. Field of the Invention

The present invention relates to help systems and, more particularly, to computer-implemented help systems.

2. Description of the Related Art

Over the last few years, more and more businesses have begun offering their services and goods online. Regardless of what goods or services are offered, there is always a need for customer support. While the traditional means of providing customer support has been by using telephone operators, it is becoming far more common for companies to offer online customer support.

Basic online customer support is often provided online by providing a list of Frequently Asked Questions (FAQs) and their answers. Some online customer support systems permit a user to search help topics to locate appropriate help information. When FAQs or searching is unable to satisfy a user, the user can sometimes contact a customer support person via email, chat or telephone. Unfortunately, as online interactions become more sophisticated, online customer support also becomes more complex. Maintaining online customer support requires engineering staff support, particular when the system relies on static help pages which require frequent updating. Thus, there is a need to improve quality and applicability of automated help services, while minimizing engineering resources required to maintain the help services offered.

Further, a help system often covers a wide range of help topics, many of which are not useful to the reader at any particular time. A user only has to spend a few minutes on the help site of a typical public corporation before it becomes clear that most any help searches inevitably turn up a large number of help topics that have nothing to do with the particular issues for which help was sought. Thus, there is also a need for improved techniques for providing context-sensitive help.

### SUMMARY OF THE INVENTION

The invention relates to methods, systems, computer readable media and graphical user interfaces for automated customer support. Automated customer support can be computer-implemented and can provide help information to users. The help information can be context sensitive and/or customized. For example, the help information can be dependent on (i) context of a help request and/or (ii) a particular user. Further, if a user requires more help than the automated customer support can provide, then the user can be provided with the opportunity to contact a customer support agent for additional assistance.

In one embodiment, a help database is used to store help information that can be retrieved and used to present help information. The automated customer support can also be referred to as a help system. Since the help system is database driven, costs (engineering support staff resources) required to maintain the automated customer support can be decreased. The database design also facilitates creation of highly modifiable and dynamic help information by interacting with a help database.

The invention can be implemented in numerous ways, including as a method, system, device, apparatus (including graphical user interface or computer readable medium). Several embodiments of the invention are discussed below.

As a computer implemented method for presenting context-sensitive help, one embodiment of the invention can, for example, include at least: providing online service support; detecting a help request from a particular user; and presenting help information to the particular user based on the particular user's answers to an ordered series of a predetermined questions.

As a computer implemented method for presenting context-sensitive help, another embodiment of the invention can, for example, include at least: presenting a user log-in prompt at an online service site; detecting a user log-in at the online service site by a particular user; retrieving a user-profile associated with the particular user; detecting a help request from the particular user; and presenting context-sensitive help information to the particular user based on the context of the help request and the user-profile.

As a system for providing context-sensitive help information to a particular authorized user, one embodiment of the invention can, for example, include at least: an online server providing an one or more services; a user-authentication server for the online service provider, the user-authentication server being configured to authorize users; a user database containing one or more user profiles, the user-database containing user profiles associated with the users of the online service provider, and the user-profiles associated with the users containing information regarding which of the one or more services provided by the online service provider are accessible to the respective users; a help database comprising help information related to the one or more services provided by the online service provider; and a help system configured to retrieve help information from the help database in response to a help request from a particular user for help, and to present the retrieved help information to the particular user. The retrieved help information being provided in response to the help request from the particular user can be based on the one or more services accessible to the particular user.

As a computer implemented method for providing context-sensitive help information to a particular authorized user, one embodiment of the invention can, for example, includes at least: presenting, at a computing device, one or more modules; authenticating a particular user for use of the one or more modules; receiving a help request for help information from the particular user; retrieving a user profile for the particular user from a user-database containing one or more user profiles, the user-profile associated with the particular user containing information regarding which of the one or more modules are available to the particular user; determining the one or more modules that are available to the particular user based on the user profile; retrieving help information related to the one or more modules based on the determined one or more modules available to the particular user; and presenting the help information to the particular user in response to the help request from the particular user. The help information being presented to the particular user can, for example, be limited to help information that pertains to one or more of the one or more modules that are available to the particular user.

Other aspects and embodiments of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a help system according to one embodiment of the invention.

FIG. 2 is a context-sensitive online help process according to one embodiment of the invention.

FIG. 3 is a context-sensitive online help process according to one embodiment of the invention.

FIG. 4 is a context-sensitive online help process according to one embodiment of the invention.

FIG. 5 is a help page creation process according to one embodiment of the invention.

FIG. 6 is a contact form creation process according to one embodiment of the invention.

FIG. 7 is a contact request creation process according to one embodiment of the invention.

FIG. 8 is an illustration of an exemplary help database according to one embodiment of the invention.

FIGS. 9(a)-13(c) are exemplary help screenshots according to embodiments of the invention.

FIG. 14 is a block diagram of a media submission and distribution system according to one embodiment.

### DETAILED DESCRIPTION OF THE INVENTION

The invention relates to methods, systems, computer readable media and graphical user interfaces for automated customer support. Automated customer support can be computer-implemented and can provide help information to users. The help information can be context sensitive and/or customized. For example, the help information can be dependent on (i) context of a help request and/or (ii) a particular user. Further, if a user requires more help than the automated customer support can provide, then the user can be provided with the opportunity to contact a customer support agent for additional assistance.

In one embodiment, a help database is used to store help information that can be retrieved and used to present help information. The automated customer support can also be referred to as a help system. Since the help system is database driven, costs (engineering support staff resources) required to maintain the automated customer support can be decreased. The database design also facilitates creation of highly modifiable and dynamic help information by interacting with a help database.

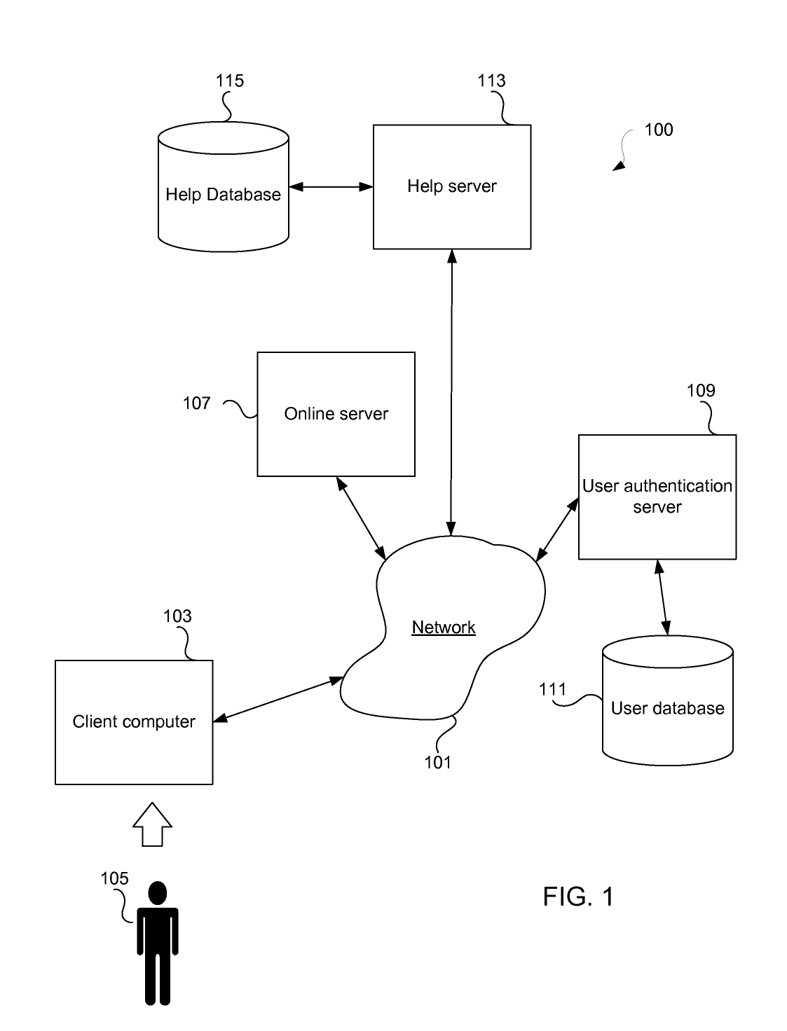

Embodiments of various aspects of the invention are discussed below with reference to FIGS. 1-14. However, those skilled in the art will readily appreciate that the detailed description given herein with respect to these figures is for explanatory purposes as the invention extends beyond these limited embodiments.

FIG. 1 is a help system 100 according to one embodiment of the invention. The help system 100 can be used to help a user 105 of a client computer 103 to obtain help with services offered by an online server 107. In the embodiment shown, the user 105 operates the client computer 103 to connect to the online server 107 across a network 1 01, for example the Internet. For example, the user 105 can operate an application program or a Web browser on the client computer 103 to connect to a web server application operating on the online server 107. The online server 107 can control access to the services it hosts by requiring the user 105 to log in to the online server 107. The user log in can be authenticated using a user authentication server 109. The user identification server 109 is shown separate from the online server 107. However, the user identification server 109 does not need to be separate from the online server 107. The user authentication server can utilize a user database 111 containing information about the user 105 (user information). The user information can, for example, include username, user password, and account information associated with the user 105. Should the user 105 require help with one or more of the services offered on the online server 107, the user can interact with a help system running on the online server 107. The help system running on the online server 107 can interact with a help server 113. Again, although the help server 113 is shown separate from the online server 107, there is no reason that the help server 113 must be separate from the online server 107. Alternately, the help system can run on the help server 113 rather than on the online server 107. In order to provide help information to the user 105, the help system can access a help database 115.

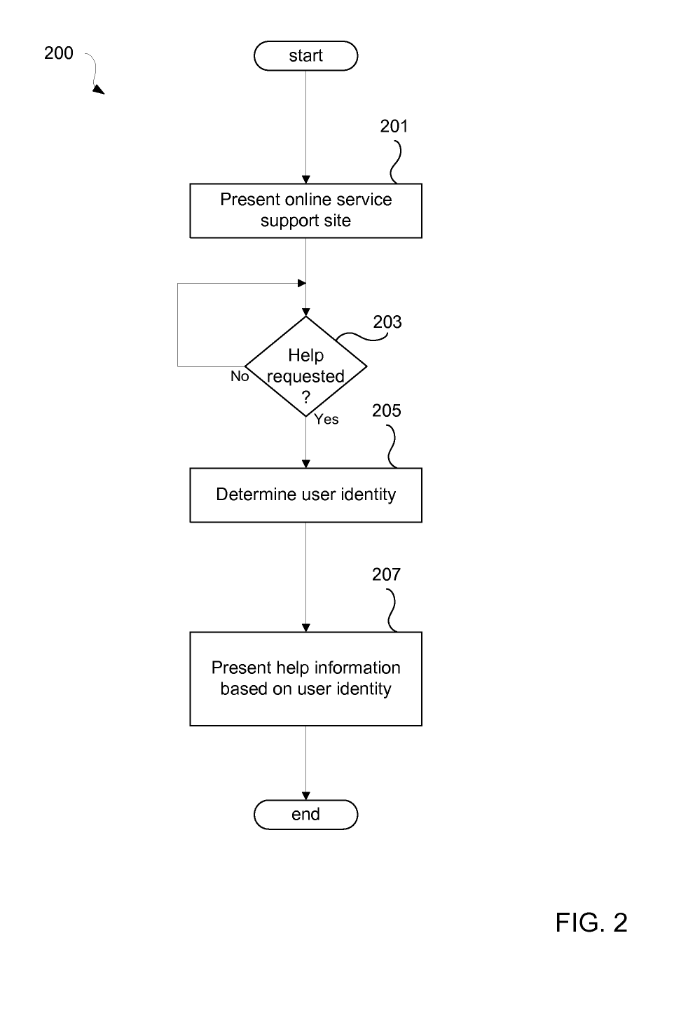

FIG. 2 is a context-sensitive online help process 200 according to one embodiment of the invention. The context-sensitive online help process 200 can be implemented, for example, using the help system 100 of FIG. 1.

The context-sensitive online help process 200 provides help information to the user of an online service. For example, a user can obtain help information from a help server in order to answer questions about a program or programs (i.e., services) running on his computer or on the website.

The context-sensitive online help process 200 can begin by presenting 201 an online service support site. For example, an online server can host an online support site. The online service support site is a support resource that can provide support (e.g., help information) for an online service. Examples of an online services include, but are not limited to, digital asset (e.g., media) submission, digital asset management, digital asset distribution, online media distribution services (e.g., via an online store). Different services can be referred to as mobiles (e.g., programming modules). As discussed below a given user can have access to only those modules that are deemed available (i.e., “visible”) to the user. If a module is not available to a user, then help information regarding such module would be excluded from the user. This enables help information that is provided to a user to be more targeted to the user.

Next, the context sensitive online help process 200 can detect 203 a help request. Upon detecting 203 a help request, the context-sensitive online help process 200 determines 205 the identity of the user making a help request. For example, the determination 205 of the identity of the user, the user could be required to log in. Alternately, the identity of the user can be determined 205 from known user information obtained from a previous user login. Finally, the context-sensitive online help process 200 presents 207 help information to the user based on the user identity. The context-sensitive online help process 200 thus provides help information to the user based on not only a context (for the help or application) but also his or her identity, rather than simply presenting generalized help information. In one embodiment, the help information can include one or more Frequently Asked Questions (FAQs). In some cases, a related FAQ can also be provided. A related FAQ is a FAQ that is not a FAQ selected for the response to a help inquiry but is related to such FAQ and thus may be of interest to the user. The related FAQs can also be restricted to “visible” modules associated with the user.

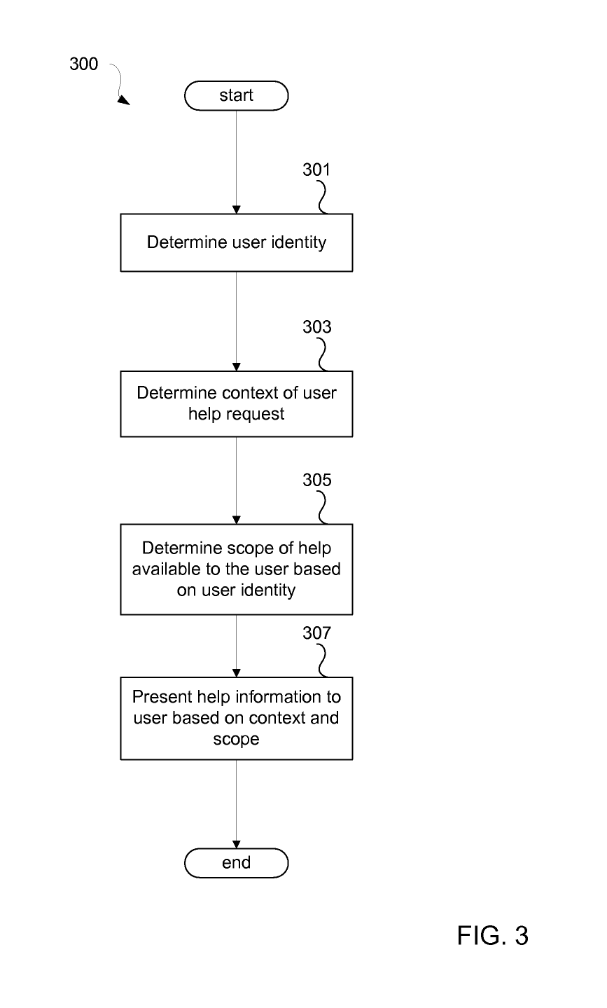

FIG. 3 is a context-sensitive online help process 300 according to one embodiment of the invention. The context-sensitive online help process 300 can be implemented using, for example, the help system 100 of FIG. 1. The context-sensitive online help process 300 provides help information to the user of an online service or program. For example, a user can obtain help information from a web-based help system in order to answer questions about a program or programs running on his computer or on a website.

The context-sensitive online help process 300 begins by determining 301 the identity of a user. For example, the identity of the user can be determined 301 by requiring a user login, e.g., prompting a user for a user name and password. Next, the context-sensitive online help process 300 determines 303 the context of a user help request. The context of the user help request can be determined 303 by checking to see from where the user is making a help request. For example, the context-sensitive online help process 300 can determine 303 what program or service the user was interacting with at the time of the help request. The help information can also be dependent on location of the user. Hence, alternately or in addition, the context-sensitive online help process 300 can determine 303 a location associated with the user. The location can pertain to a default location for the user or can be a determined location for the user. For example, a current location can be a determined location using GPS or wireless networks. Hence, in some cases, the determination 303 of the context of the user help request can include the user's location (e.g., geographical location). Similarly, a country associated with the user's account information can be utilized in the determination 303 of the context. For example, if a user is using an administration tool on a website and requests help from the help system of the website, the context sensitive help system will determine 303 that the user was using the administration tool (i.e., the context) and provide help for the administration tool.

Next, the scope of the help available to the user is determined 305 based on the user's identity. The scope of the help can vary depending on one or more of a wide variety of factors. These factors can include, for example, whether the user has a user agreement or a service plan and what activities are covered by the agreement or the service plan, what services are offered to users in the country in which the user resides, and what service the user is currently using. For example, if two users with different service plans make the same help request for help with an administrative tool, the scope of the help available to each user can be different. After the scope of help available to the user is determined 305, the context-sensitive online help process 300 continues by presenting 307 help information to the user based on the context of the user help request and the scope of the help information available to the user.

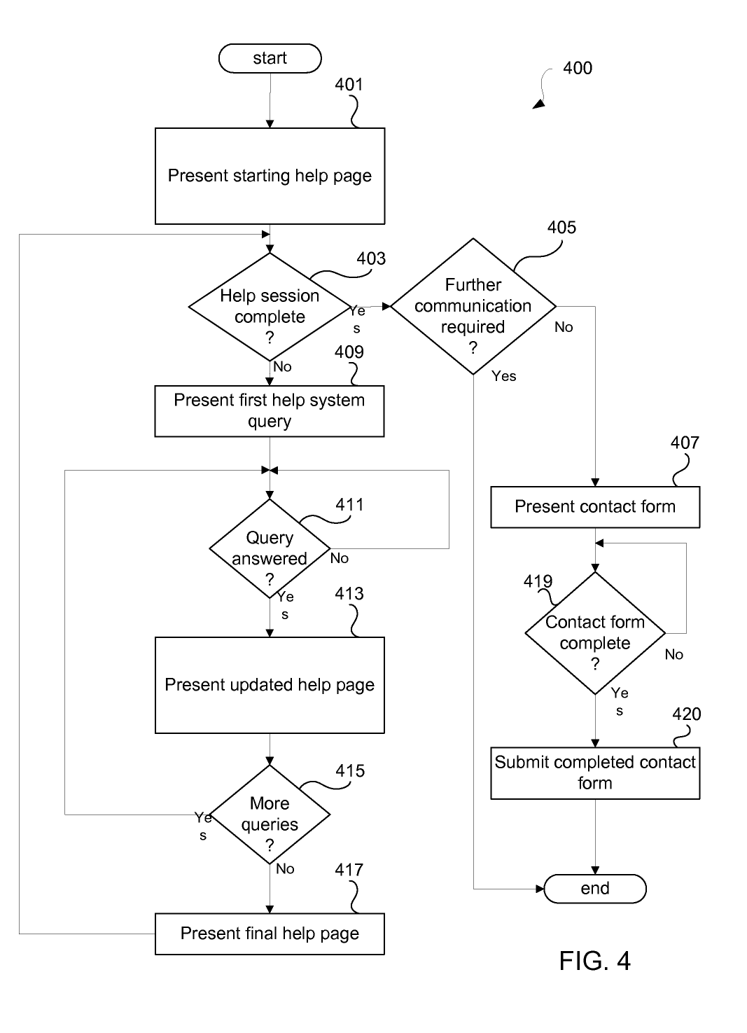

FIG. 4 is a context-sensitive online help process 400 according to one embodiment of the invention. The context-sensitive online help process 400 can be implemented using, for example the help system 100 of FIG. 1. The context-sensitive online help process 400 provides help information to the user of an online service or program. For example, a user can obtain help information from a web server in order to answer questions about a program or programs running on his computer or on the web server.

The context-sensitive online help process 400 can begin by presenting 401 a help starting page. The help starting page can be, for example, a help page presented at or to the user when the user initially makes a help request. In one embodiment of the invention, the help starting page can take into account the user's identity and the context of the user's help request as described above in reference to FIG. 3. The context-sensitive online help process 400 then determines 403 if the help session is complete. For example, if the help page presented 401 to the user provides enough information to the user for the user to have his question answered to his satisfaction, then the help session can be complete. Alternately, if the user does not feel that his question has been answered by the page presented 401, the user may request additional help from a customer service agent, ending his interaction with the help system. If the context sensitive online help process 400 determines that the help session is complete, a determination 405 determines if the user desires further communication with a customer service agent. If so, then the context-sensitive online help process 400 continues to block 407. Once the contact form has been presented 407, a decision 419 can detect whether the contact form presented 407 has been completed. When the contact form has been completed, the completed contact form can be submitted 420. After the completed contact form has been submitted, the context-sensitive help process 400 can end. If, on the other hand decision 405 determines that no further communication is required by the user, then the context-sensitive online help process 400 can end.

In one embodiment, the submitted contact form can thereafter be directed to an appropriate customer service representative. For example, the submitted contact form can be routed to the appropriate customer service representative by electronic mail (email). In one implementation, a help database (e.g., help database 115) can assist with routing by storing email addresses for the appropriate customer service representatives. In other words, a submitted contact form can be routed differently depending on the context or topic of a submitted contact form or a help request contained therein.

Returning to decision 403, if decision 403 determines that the help session is not complete, such as if the user requires additional information from the help system, then the context sensitive online help process 400 presents 409 a first help system query. Help system queries can be standard prepared questions that the help system presents to the user in order to determine how best to help the user. The first help system query can be generic or can be context and/or user dependent. In one embodiment, a help system query can be presented as a question and an accompanying set of possible answers that are chosen from a pop-up menu. Next, a decision 411 detects if the help system query that was presented 409 to the user has been answered. Once decision 411 detects that an answer has been presented 409, the help page can be updated 413 to address the user's answer. For example, the help page can be updated 413 to present the answer to a frequently asked questions (FAQ) that is relevant to the user's answer to the help system query. Alternately, the user's answer to the help system query can cause the context-sensitive online help process 400 to present 413 an updated help page with a follow up help system query.

The context sensitive online help process 400 continues to a decision 415 that detects if the updated help page presented 413 contains any unanswered help system queries. If so, the context-sensitive online help process 400 continues to block 411 and subsequent blocks. If on the other hand the context-sensitive online help process 400 does not detect any unanswered help queries, then a final help page is presented 417. The final help page presented 417 can, for example, present 417 to the user (i) one or more answers to FAQs, (ii) instructions on how to address the user's help needs, and/or (iii) a contact form for the user to fill out and send to a customer service representative who can help the user resolve his help issue. Once the final help page has been presented 413, the context-sensitive online help process 400 can return to block 403 and subsequent blocks.

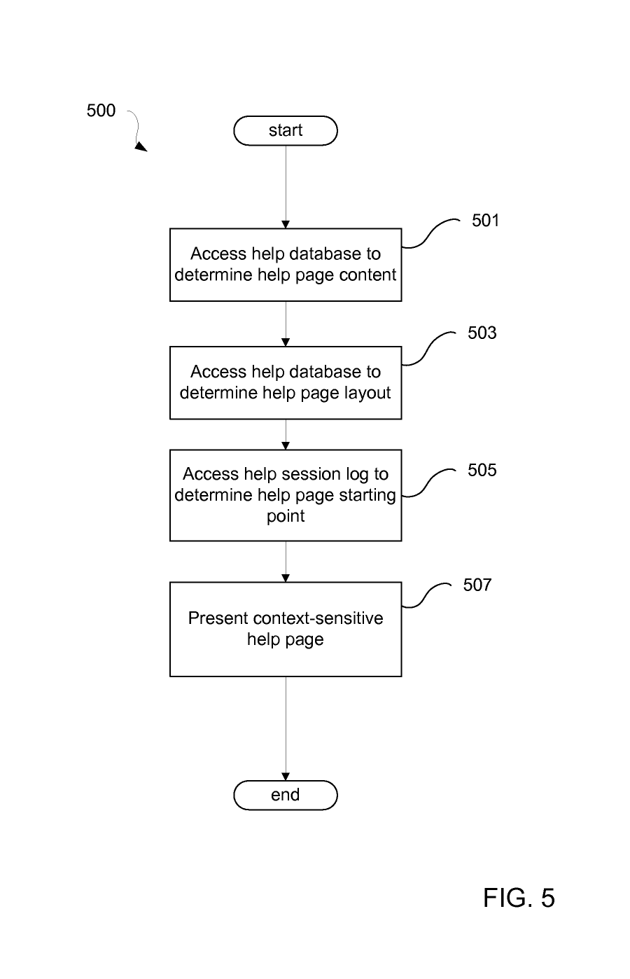

FIG. 5 is a help page creation process 500 according to one embodiment of the invention. The help page creation process 500 can, for example, occur when the context-sensitive online help process 400 of FIG. 4 presents 401 a starting help page. In one embodiment, the help page creation process 500 is invoked when a request to create a help page is made. Thus, in this embodiment, all the data to create and update the help page is retrieved from a database (e.g., in one or more database queries), namely, a help database. For example, in the context-sensitive online help process 400 described above, all help system queries, form data, help page formatting, and FAQ answers occur once per help request. Further, whenever a help page is updated, the help page creation process 500 can also be invoked. For example, in the context-sensitive online help process 400 described above, the help page creation process 500 occurs before a help page is presented 401 and/or updated 413, or before a contact form is presented 407. Note that the help database that is used to create the help page according to the help page creation process 500 can be, for example the help database 115 of FIG. 1.

The help page creation process 500 can begin by accessing 501 a help database to determine help page content for a particular help page to be created. Help page content can include, for example, text, hyperlinks, figures, pictures, form data, and FAQs/FAQ answers. The help database can also be accessed 503 to determine the layout of the help page. The layout of the help page can include, for example HTML or XML tags, form controls such as pop-up menus, radio buttons, checkboxes, and text boxes, or other formatting data that can be used to present help page content.

Once the help page content and help form layout are known, a help session log can be accessed 505 in order to determine an access point for the help page that is to be created. The help session log can be a session log maintained for the help server. In one implementation, the session log is maintained at the help server (e.g., help server 113), online server (online server 107) or other accessible server. The client computer (e.g., client computer 103) can store a website code (e.g., “cookie”) to assist in maintaining the session log. Alternately, the help session log can be stored in a database that is associated with a particular user's user information and is created and/or updated whenever the user accesses the help system. The help session log can contain, for example, user-identity, help-context, and help-scope information as described in FIG. 3 above. The help session log can also be use to log the help information (e.g., FAQs) previously provided to a user so that, in one embodiment, it is less likely that the user would receive the same help information (e.g., FAQ) after it was previously provided yet failed to satisfy the user's issue.

Once the help page creation process 500 has the information necessary to create the help page (i.e., help page content, help page layout, and/or help starting page), then a context sensitive help page based on the information can be presented 507.

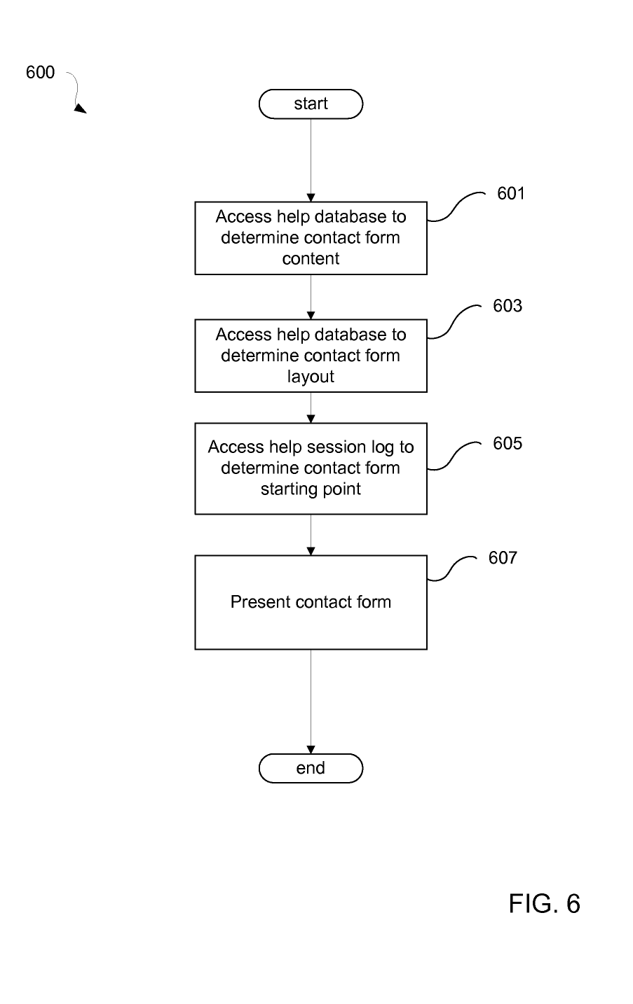

FIG. 6 is a contact form creation process 600 according to one embodiment of the invention. The contact form creation process 600 can occur, for example, when a contact form is presented 407 as described in FIG. 4 above.

The contact form creation process 600 can begin by accessing 601 a help database to determine the contact form content. Contact form content can include, for example, text, hyperlinks, figures, pictures, and contact form routing information (e.g., customer service agent e-mail addresses). Next, the help database can be accessed 603 to determine the layout for the contact form. As noted above in reference to FIG. 5, the accessing 601 of the help database and/or the accessing 603 of the form layout information can occur at any time prior to the presenting of the contact form and is not necessarily delayed until just before the presentation of the contact form. Note that the help database that is used to create the help page according to the help page creation process 600 can be, for example the help database 115 of FIG. 1.

Next, the help session log can be accessed 605 in order to determine a starting point for the contact form. For example, the help session log as described above in reference to FIG. 5 can be utilized. In one embodiment of the invention, the help session log includes user information that can be used to pre-populate form data on the contact form. For example, the user's name and account number can be extracted from the help session log. Finally, the contact form creation process 600 presents 607 the contact form using the information gathered in blocks 601-605. Note that not all information gathered by the contact form creation process 600 needs to be presented to the user. For example, user's account information can be stored in the session log for later use and not presented to the user at the time of the presentation 607 of the contact form. The reason for this is that the amount of information retrieved may be substantially more than is necessary to present a contact form. However, the information can be useful to the recipient of the completed contact form (e.g., a customer service representative) at some point in the future. Thus, information that is not displayed to the user when the contact form is presented 607 can be embedded in the contact form for later use.

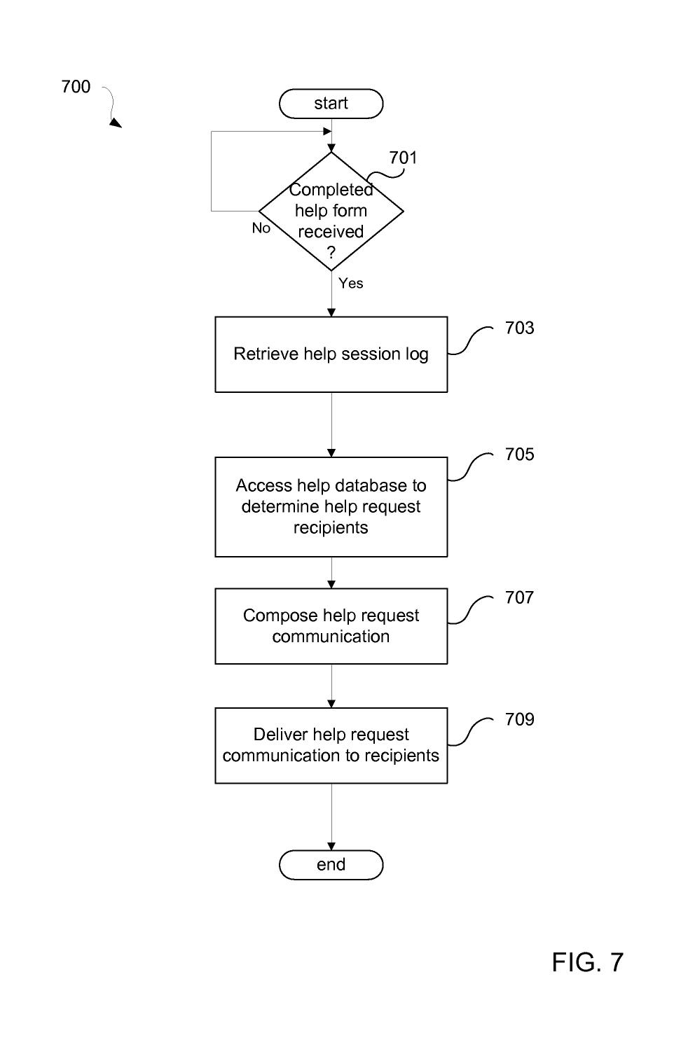

FIG. 7 is a contact request creation process 700 according to one embodiment of the invention. The contact request creation process can occur, for example, following submission 420 of a contact form as discussed above in reference to FIG. 4.

The contact request creation process 700 can begin with a decision 701 that determines if a completed help form has been received. If decision 701 determines that a completed help form has been received, a help session log is retrieved 703. The help session log can be, for example, the help session log as described in reference to FIG. 5. Next, a help database can be accessed 705 in order to determine who the recipient of the help request will be. For example, the help database 115 as described in FIG. 1. According to one embodiment, the recipient of the help request can be a customer service agent and the information that is gained by accessing 705 the help database can include at least one customer service representative or customer service group e-mail address. Once the help database has been accessed 705 to determine who will receive the help request, the help request can be composed 707. The composition 707 of the help request can include the data received from the completed help form, information stored in the help session log, and/or additional information associated with the user identity information associated with the user who completed the help form. Additional information can include, for example, previous help session logs for the same customer. According to one embodiment, help session logs are stored in a user database, for example the user database 111 as described in FIG. 1. Once the help request communication has been composed 707, the help request communication can be delivered 709 to one or more of the recipients determined when the help database is accessed 705.

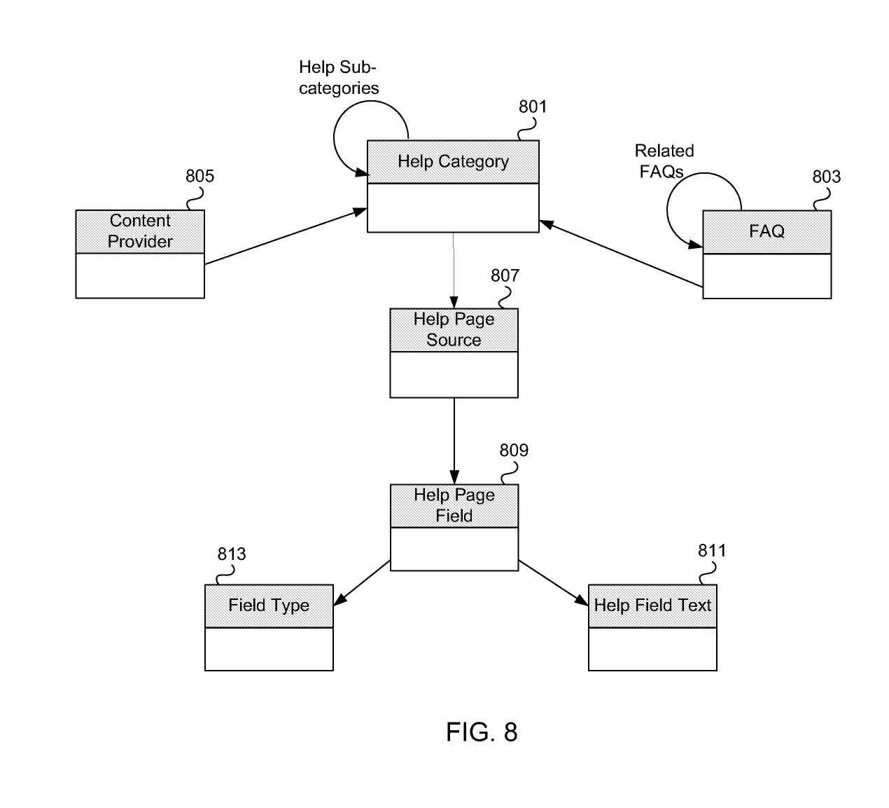

FIG. 8 is an illustration of an exemplary help database 800 according to one embodiment of the invention. The database includes a variety of database objects, including help category objects 801. Each help category object 801 can have one or more help subcategories, each itself a help category object 801. In addition, each help category object 801 may be associated with one or more FAQ objects 803. FAQ objects 803 can be associated with a FAQ object. 803 that contains or identifies one or more related FAQs.

As discussed above in reference to FIG. 3, help offered to a particular user can vary in scope depending on the user type. Thus, the exemplary help database 800 can also include a user type object 805. The user type object 805 can contain information as to what type of user is able to see information with respect to each of the help categories.

Help category objects 801 can each have an associated help page source object 807. Thus, each help category can be expressed as a help page with text, graphics, etc. laid out according to formatting instructions contained in the help page source object 807. The help page source object 807 can include one or more help page fields, each defined by a help page field object 809, and each having a field type defined by a field type object 813. Examples of field types include pop-up menus, text fields, buttons, and the like. Help page fields can have associated text defined by help field text objects 811. For example, pop-up menus typically offer a variety of menu choices, where each of the menu choices is expressed as a text string and contained in a help field text object 811.

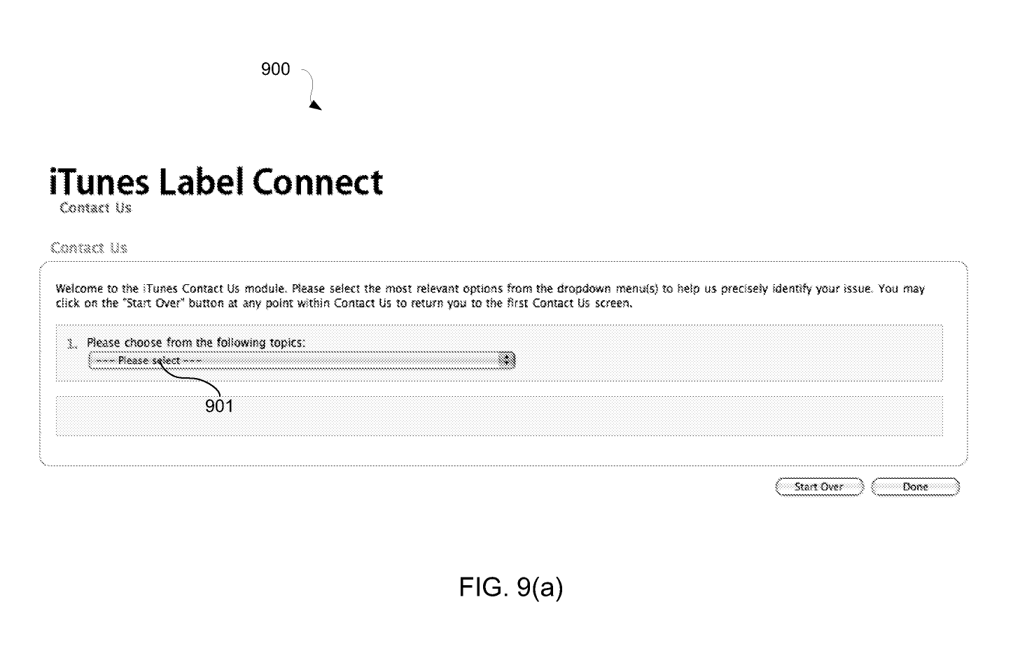

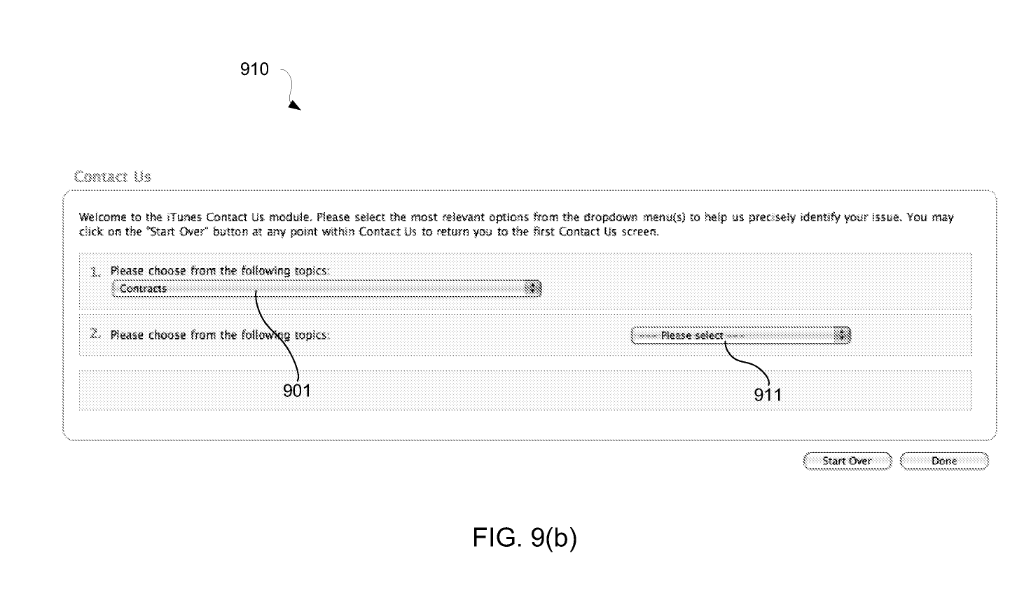

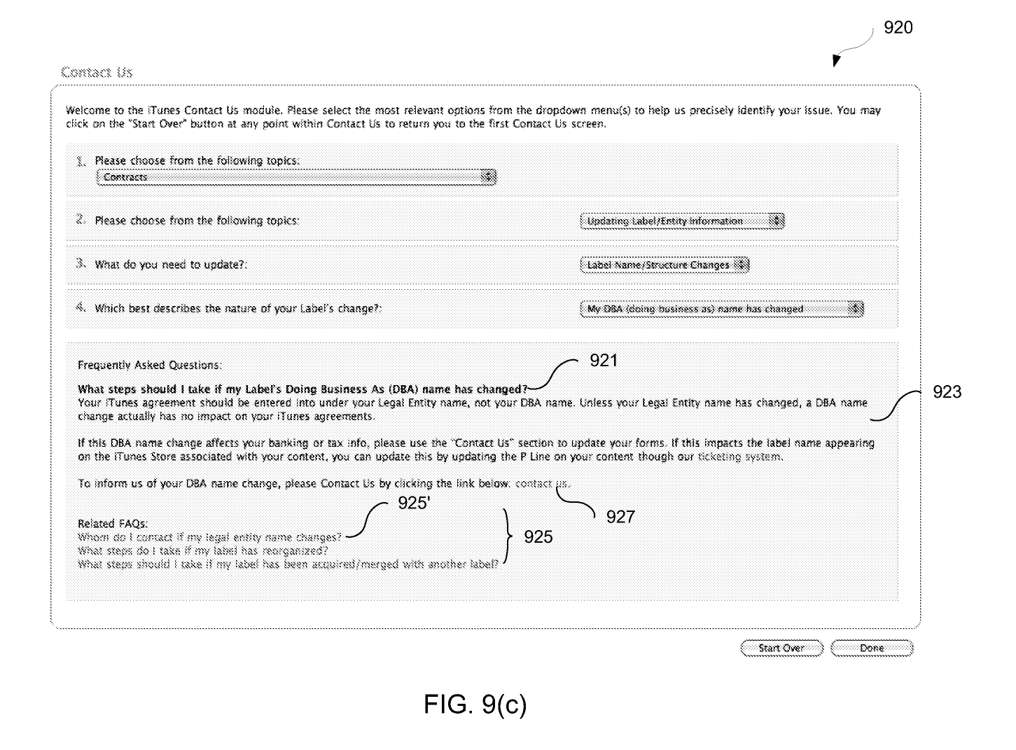

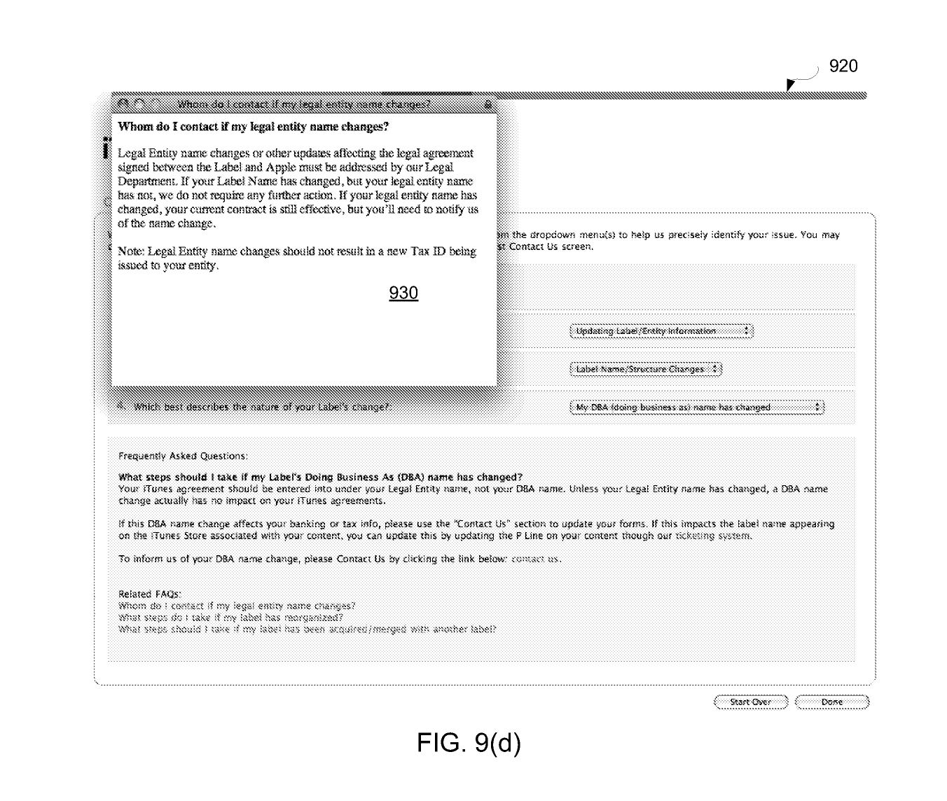

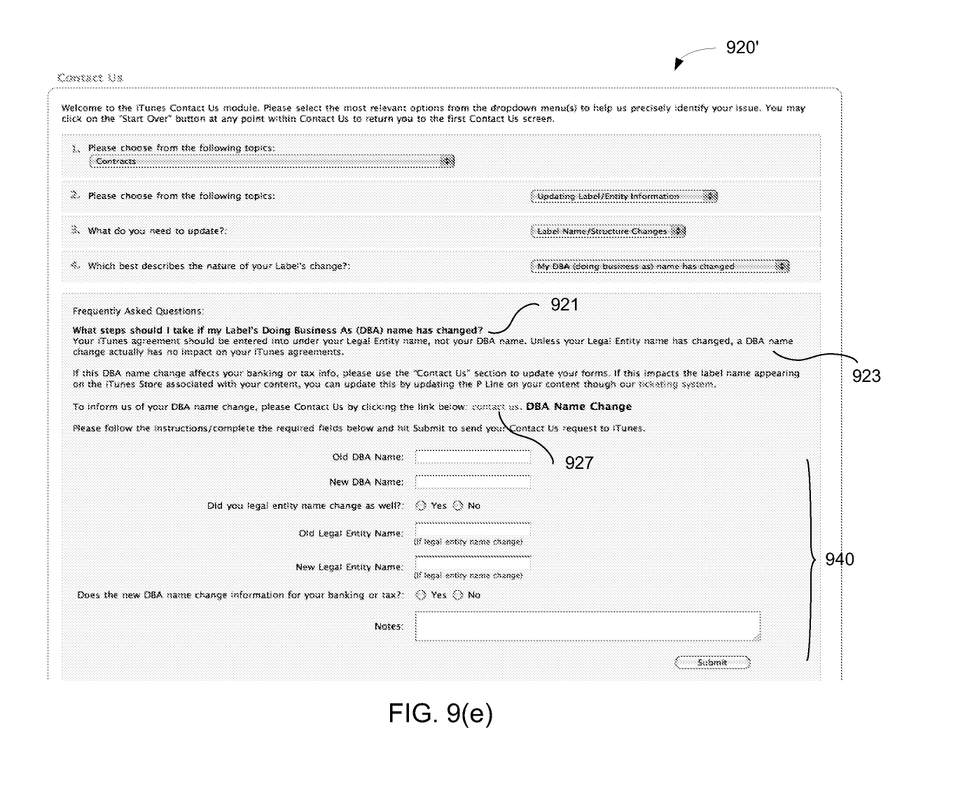

FIGS. 9(a)-13(c) are exemplary help screenshots according to embodiments of the invention. These exemplary help screenshots pertain to a help system pertains to help for iTunes™ Label Connect which is a client or server application or service that enables users (e.g., content providers) to submit and management media content that is to be distributed (e.g., sold or rented) at an online media store (e.g., iTunes™ Music Store). The help information and layout for each screenshot can be provided by the help database 800 of FIG. 8.

FIGS. 9(a)-9(e) are a series of exemplary help screenshots according to one embodiment of the invention.

FIG. 9(a) depicts a starting help page 900 according to one exemplary implementation. The help page 900 can be created by querying the help database 800. In particular, a help category object 801, which refers to a help page source object 807, can be retrieved. The help page source object 807 refers to help page fields 809, which in turn refer to field types 813 and help field text 811. Additionally, the help category object refers to one or more FAQ objects 803. The information retrieved can be used to create and present the starting help page 900. The help page 900 is laid out according to the layout defined in the help database 800 and is shown with a single help page field 809, in this case a pop-up menu 901 with a default menu item “-- -- -- Please select -- -- --” initially selected. A user can select a help topic from the pop-up menu 901.

FIG. 9(b) depicts a help page 910, which has been dynamically updated after a user has made a selection from the pop-up menu 901 described in FIG. 9(a). In this case, the user has selected “Contracts” from the pop-up menu 901 illustrated in FIG. 9(a). Upon making the selection, the help page 900 of FIG. 9(a) is updated to help page 910 illustrated in FIG. 9(b). The help page 910 presents a second pop-up menu 911 as well as the previous pop-up menu 901. The second pop-up menu 911 enables a user to select a help sub-topic from the pop-up menu 911.

FIG. 9(c) depicts a help page 920, which represents several updates of the help page 900 after a user has made selections from a series of pop-up menus. In addition to the pop-up menus as described above, the updated help page 920 presents a FAQ 921 as well as its answer 923. Below the FAQ 921, related FAQs 925 can be presented. A related FAQ is a FAQ that is predetermined to be related to another FAQ. The database can be accessed to determine the FAQ 921 and the related FAQs 925. In addition, a contact request link 927 can also be presented.

FIG. 9(d) depicts a pop-up window 930 that can be displayed when a user has selected a particular link 925′ for one of the related FAQs 925 displayed on help page 920.

FIG. 9(e) depicts a help page 920′ that has been updated from the help page 920 illustrated in FIG. 9(c). The help page 920′ includes a contact request form 940 (or contact request region) instead of or in addition to the related FAQs 925. The help page 920′ is presented when a user selects the contact request link 927 of FIG. 9(c). Note that the contact request form is specific to the FAQ answer 923 of FIG. 9(c).

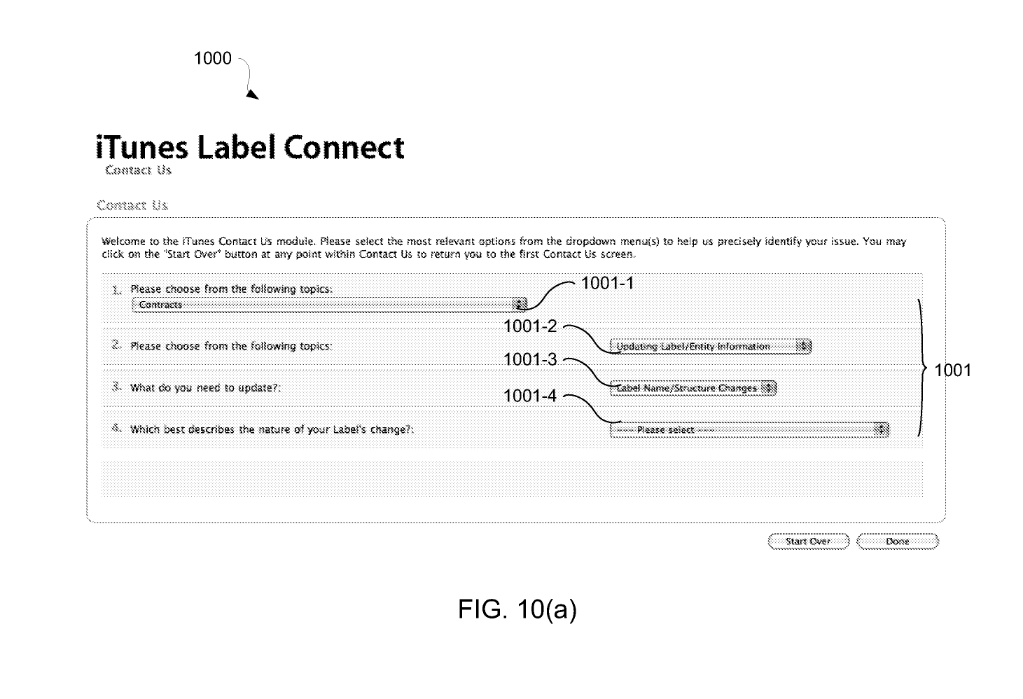

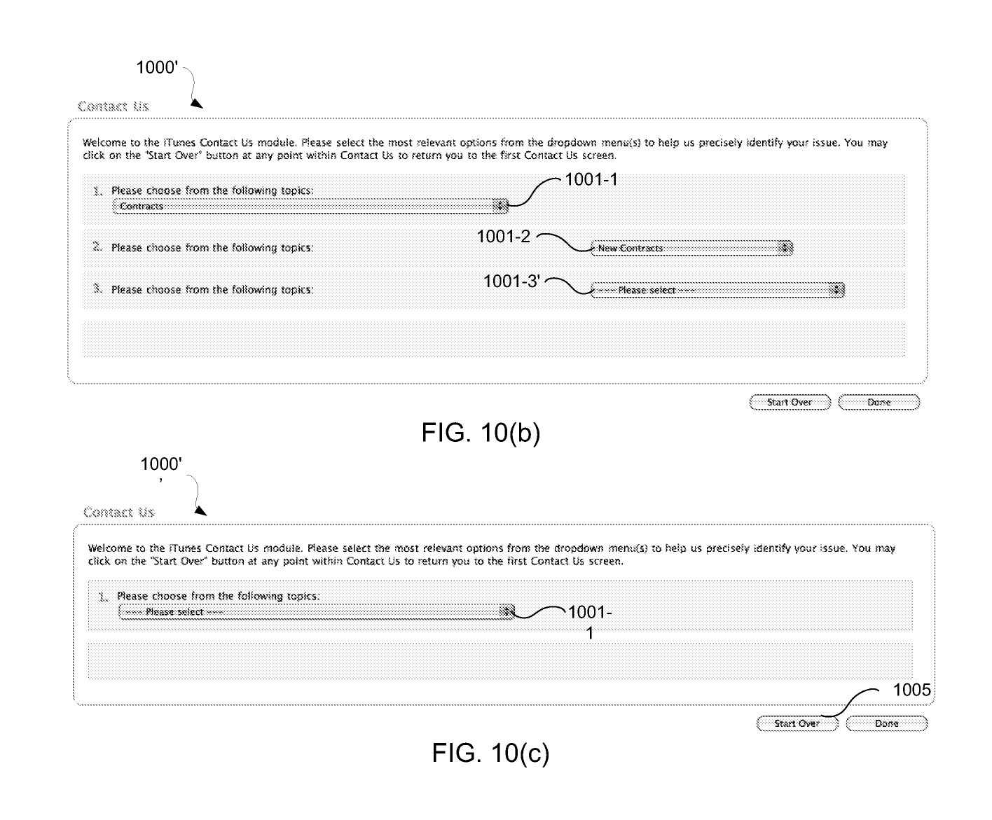

FIGS. 10(a)-10(c) are a series of exemplary help screenshots according to another embodiment of the invention.

FIG. 10(a) depicts a help page 1000 according to another exemplary implementation. The help page 1000 is similar to starting help page 910 referred to in FIG. 9(a), but shows a help page after several pop-up menus 1001 have been selected by a user. Note that each pop-up menu 1001 (and its associated text) can, for example, appear only after the previous pop-up menu has been selected. In other words, the subsequent pop-up menus are dependent on one or more of the previous menu selections. Thus, pop-up menu 1001-2 appears after pop-up menu 1001-1 has been selected. Similarly, pop-up menu 1001-3 appears after pop-up menu 1001-2 has been selected, and pop-up menu 1001-4 appears after pop-up menu 1001-3 has been selected. Finally, pop-up menu 1001-4 displays default help field text: “-- -- -- Please select -- -- --”, and awaits a user selection.

FIG. 10(b) depicts a help page 1000′. The help page 1000′ represents an updated version of the help page 1000 after the value for pop-up menu 1001-2 has been changed. Referring back to FIG. 10(a), it can be seen that pop-up menu 1001-2 displays the text “updating label/entity information” as its selected sub-topic. In contrast, in FIG. 10(b) pop-up menu 1001-2 now displays the text “new contracts” as its selected sub-topic. This indicates that a user has elected to change its selected sub-topic with respect to pop-up menu 1001-2. As a consequence, pop-up menu 1001-3′ (and its associated text) presented in FIG. 10(b) instead of pop-up menu 1001-3. Since pop-up menu 1001-3′ is new it initially presented a default menu selection “-- -- -- Please select -- -- --”. Note further that pop-up menu 1001-4 disappears altogether because no answer has yet been selected for pop-up menu 1001-3′. Here, the help page 1000 can dynamically update to the help page 1000′ as soon as the value of pop-up menu 1001-2 has been changed.

FIG. 10(c) depicts a help page 1000″. The help page 1000″ represents an updated version of the help page 1000 or the help page 1000′ after a “start over” button 1005 has been selected. Selecting the “start over” button 1005 resets the help page 1000 or the help page 1000′ to its starting state and clears the values for all pop-up menus 1001.

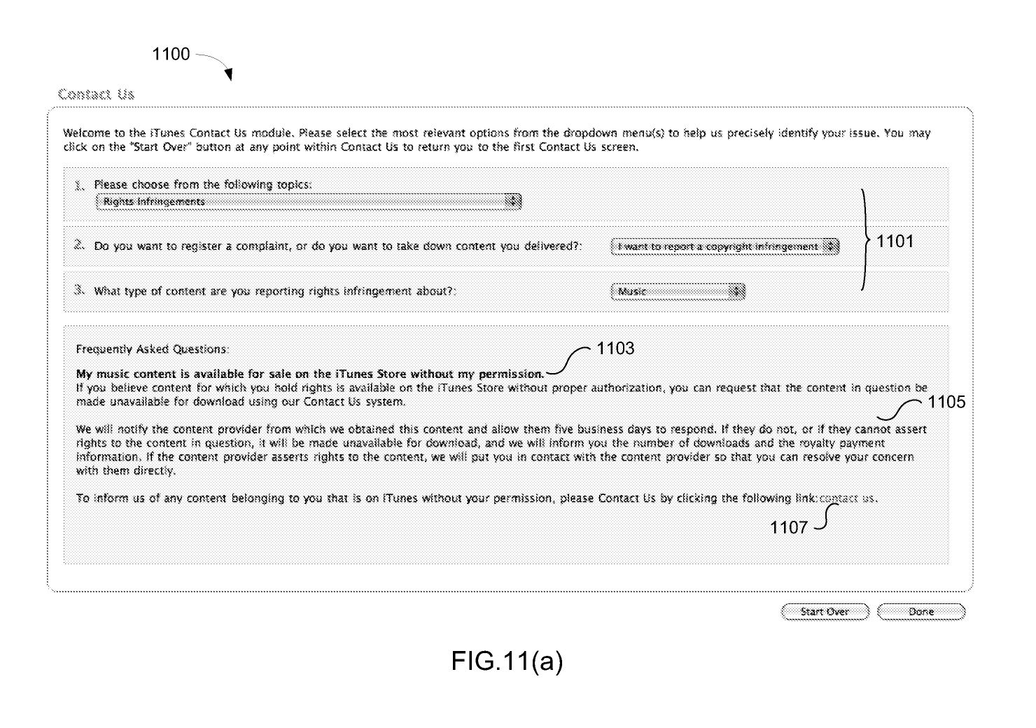

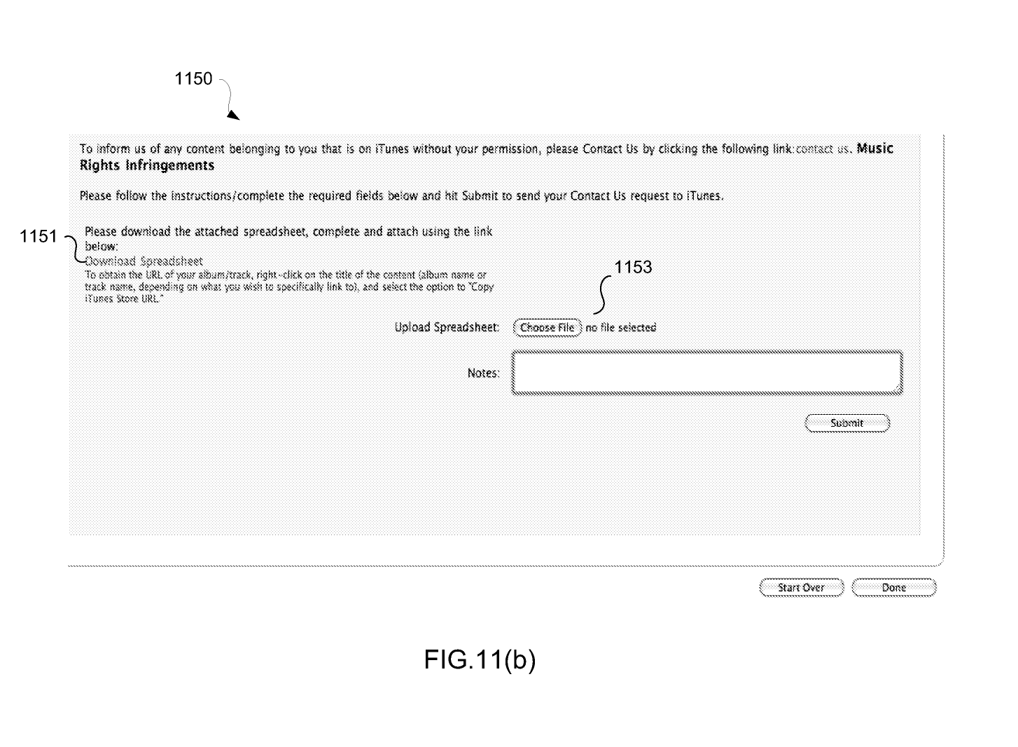

FIGS. 11(a) and 11(b) are a series of exemplary help screenshots according to another embodiment of the invention.

FIG. 11(a) depicts a help page 1100 according to another exemplary implementation. The help page 1100 has general similarity to the help page 920 of FIG. 9(c). Specifically, FIG. 11(a) depicts the help page 1100 following being dynamically updated after a user has answered three questions using pop-up menus 1101. In addition to the pop-up menus 1101, the help page 1100 presents a FAQ 1103, an answer 1105 to the FAQ 1103, and a contact request link 1107.

FIG. 11(b) depicts a download page 1150 according to one embodiment of the invention. The download page 1150 can be presented after the contact request link 1107 of FIG. 11(a) has been selected by the user. The download page 1150 has a download link 1151. In this example, the download link 1151 pertains to downloading of a spreadsheet that is useful for the help requested by the user. The download page 1150 also depicts an upload control 1153. Here, the topic and sub-topic selection with respect to pop-up menus 1101 provide a context for the download page 1150. In this example regarding rights infringement, the user is requested to download, complete and re-attach (upload) the spreadsheet.

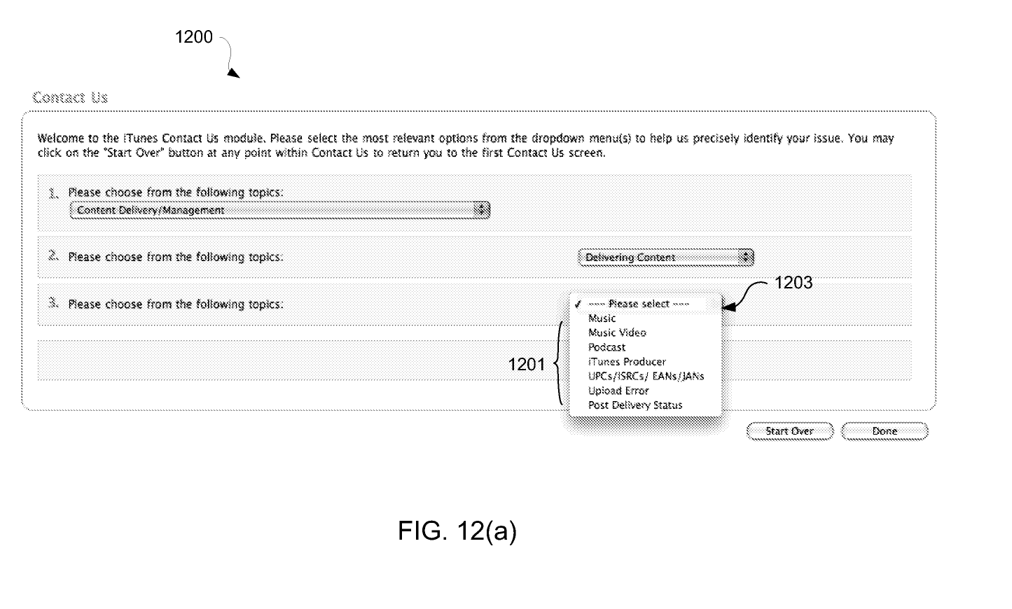

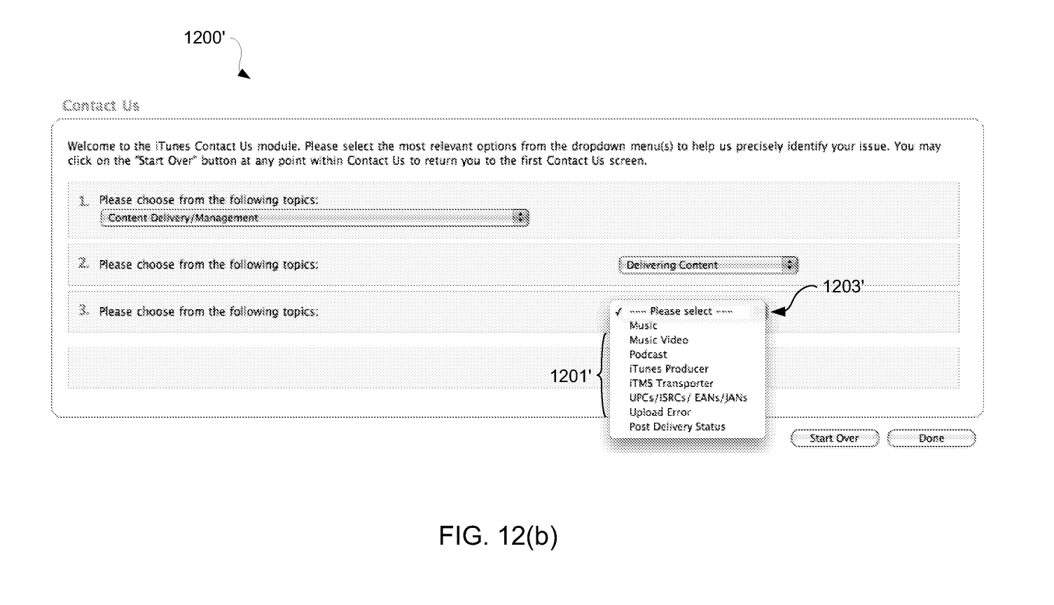

FIGS. 12(a) and 12(b) are a series of exemplary help screenshots according to another embodiment of the invention.

FIG. 12(a) depicts a help page 1200 according to another exemplary implementation. As discussed above, in one embodiment, the scope of help available to a particular user may not be the same as the scope of help available to a different user. For example, different users can have access to different one or more modules served by a help system. FIG. 12(a) depicts seven help topics 1201 that are available for selection by a user from a pop-up menu 1203. These help topics 1201 are sub-topics that are use in provided the user with relevant help information.

FIG. 12(b) depicts a help page 1200′ that is generally similar to the help page 1200 as depicted in FIG. 12(a). However, the scope of help available on help page 1200′ is different than the scope of help available on help page 1200. Specifically, pop-up menu 1203′ presents eight help topics 1201′ rather than the seven help topics that are available on help page 1200. Here, it is assumed that the user of the help page 1200′ is a different user that the user of the help page 1200. Moreover, the user of the help page 1200′ has access to a greater scope of help than is the user of the help page 1200. More example, due to user profile (e.g., user type or user classification), the help information, here the help topics (i.e., menu choices) in the pop-up menus 1203 and 1203′ can be different for different users. The user of the help page 1200′ has access to help information concerning “iTMS Transporter”, which is a media submission software tool, but the user of the help page 1200 does not.

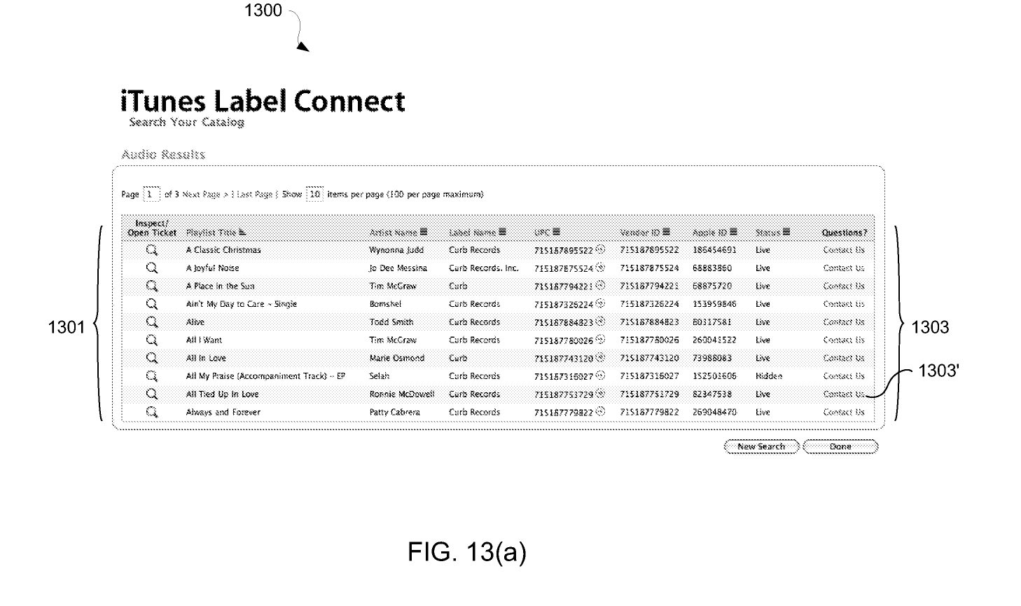

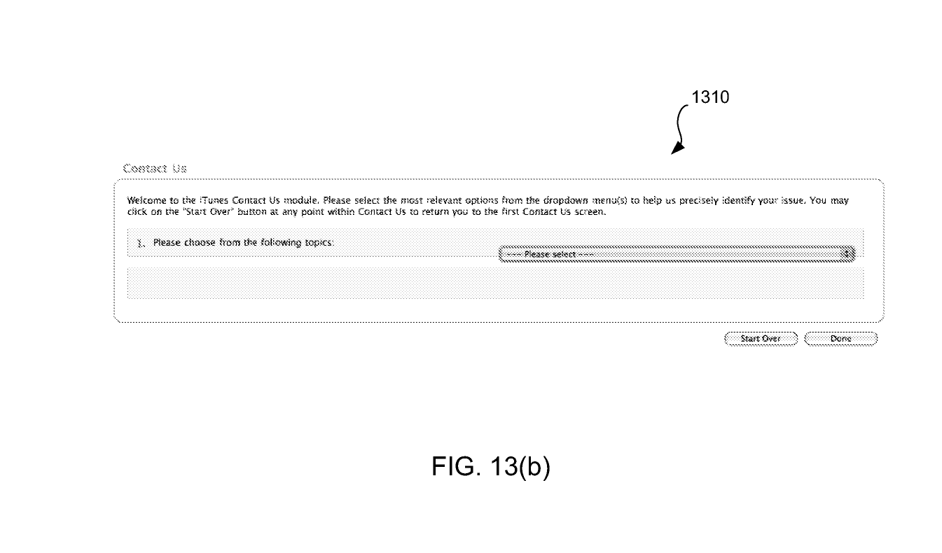

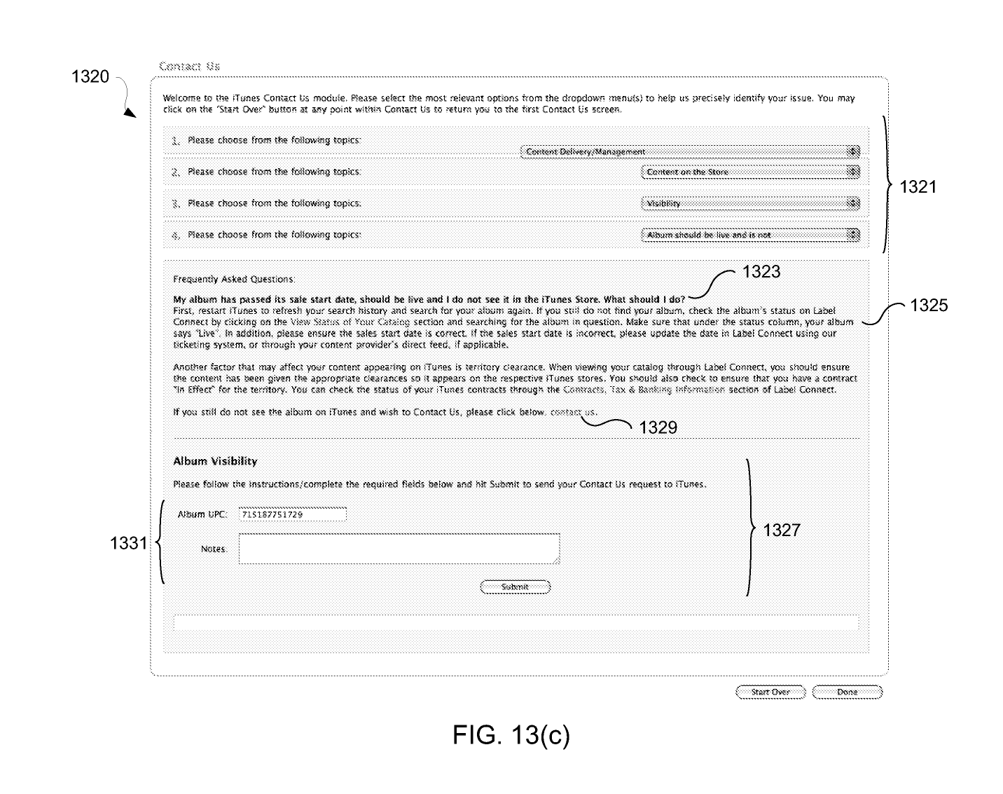

FIGS. 13(a)-13(c) are a series of exemplary help screenshots according to still another embodiment of the invention.

FIG. 13(a) depicts a music catalog search page 1300 according to one exemplary implementation. As shown, a series of media collections 1301 (e.g., music albums) are displayed. A contact request links 1303 is displayed for each of the media collections 1301. For the purposes of illustration 13(c) below, we will assume that link 1303′ in FIG. 13(a) was selected.

FIG. 13(b) depicts a starting help page 1310 according to one exemplary implementation. The starting help page 1310 can be accessed by selection of any of the contact request links 1303 depicted in FIG. 13(a).

FIG. 13(c) depicts an updated help page 1320. The updated help page 1320 follows from the starting help page 1310 and can be presented after a user has made selections from a series of pop-up menus 1321. In addition to the pop-up menus 1321, the updated help page 1310 presents an FAQ 1323 as well as its answer 1325. The help page 1320 also shows a contact request form 1327 (or contact request region). The contact request form 1327 can, for example, appear after a user has clicked on a contact request link 1329. The contact request form 1327 in this example depicts two text fields 1331. As discussed above in reference to FIG. 6, a help session log can be used to pre-populate text fields. Hence, the contact request form 1327 is depicted with one pre-populated field. Specifically, the “Album UPC” field has been pre-populated with the UPC code for the music album associated with contact request link 1303′, as described above with reference to FIG. 13(a). In one implementation, a help session log can have stored the “Album UPC” when the contact request link 1303′ was selected such that it can later be retrieved from the help session log when later useful, such as for field pre-population.

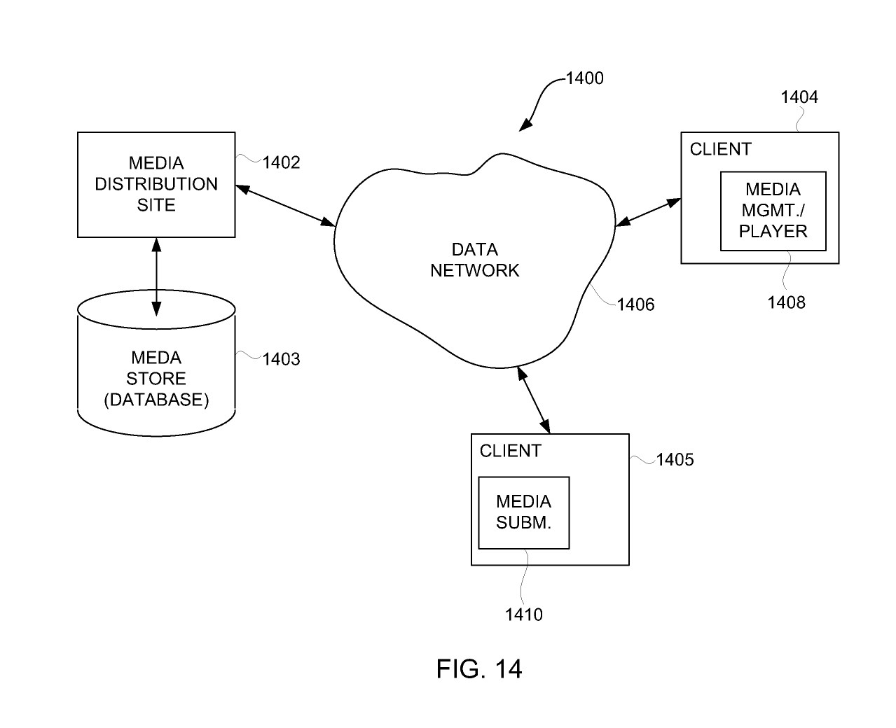

FIG. 14 is a block diagram of a media submission and distribution system 1400 according to one embodiment. The automated customer support according to the invention can be implemented to provide help information to user of the media submission and distribution system 1400.

The media submission and distribution system 1400 includes a media distribution site 1402. The media distribution site 1402 coordinates submission (receipt), storage and purchase of media items. The media distribution site 1402 stores media items in a media store 1403. In one embodiment, the media store 1403 is a database. The media store 1403 provides mass storage of the numerous media items that are available for purchase. Once purchased, the media items can be accessed from the media store 1403 over a data network 1406 by way of the media distribution site 1402.

The media submission and distribution system 1400 also includes a first client 1404 and a second client 1405. Typically, the media submission and distribution system 1400 would include a plurality of different clients 1404,1405. The first client 1404 includes a media management/player 1408. The second client 1405 includes a media submission program 1410. Some clients can also include both the media management/player 1408 and the media submission program 1410. The media management/player 1408 is an application program (e.g., software application) that operates on the first client 1404, which is a computing device. One example of a suitable media management/player 1408 is iTunes™ offered by Apple Computer, Inc. The first client 1404 is coupled to the media distribution site 1402 through the data network 1406. Hence, any of the first clients 1404 can interact with the media distribution site 1402 to review, purchase and/or manage media items.

The media submission program 1410 is also an application program (e.g., software application) that operates on the second client 1405, which is a computing device. The media submission program 1410 is used to submit media items to the media distribution site 1402. Although the media management/player 1408 and the media submission program 1410 are shown in FIG. 14 as separate programs, it should be understood that such programs can be integrated into a single program or reside on the same second client.

In the media submission and distribution system 1400 shown in FIG. 14, the media items are submitted to the media distribution site 1402 by way of the media submission program 1410. The media items that have been submitted (e.g., via the second client 1405) are processed and then stored in the media store 1403. Thereafter, the stored media item are available to be purchased from the media distribution site 1402. Upon purchasing a particular media item, the media distribution site 1402 permits the media content for the particular media item to be retrieved from the media store 1403 and then delivered (e.g., downloaded) from the media distribution site 1402 to the corresponding client 1404 through the data network 1406. In this regard, the media distribution site 1402 obtains the media content corresponding to the particular media item from the media store 1403 and downloads such content through the data network 1406 to the client 1404. The downloaded media content can then be stored on the client 1404. In one embodiment, the downloaded media content is encrypted as received at the client 1404 but is decrypted and then perhaps re-encrypted before persistent storage on the client 1404. Thereafter, the media management/player 1408 can present (e.g., play) the media content at the client 1404.

The media submission and distribution system 1400 allows a user of the client 1404 to utilize the media player 1408 to browse, search or sort through a plurality of media items that can be purchased from the media distribution site 1402. The media management/player 1408 may also allow the user to preview a media clip of the media items. In the event that the user of the media management/player 1408 desires to purchase a particular media item, the user (via the media management/player 1408) and the media distribution site 1402 can engage in an online commerce transaction in which the user pays for access rights to the particular media item. In one embodiment, a credit card associated with the user is credited for the purchase amount of the particular media item.

The submission and purchase of the media items can be achieved over a data network 1406. In other words, the submission and purchase of the media items can be achieved online. The purchase of media items online can also be referred to as electronic commerce (e-commerce). In one embodiment, the data network 1406 includes at least a portion of the Internet. The clients 1404 can vary with application but generally are computing devices that have memory storage. Often, the clients 1404 are personal computers or other computing devices that are capable of storing and presenting media to their users.

The connections through the data network 1406 between the media distribution server 1402 and the clients 1404,1405 can be through secure connections, such as Secure Sockets Layer (SSL). Further, the media content can be re-encrypted prior to storage at the client 1404 such that downloaded media content is not stored in the clear, but is instead stored in an encrypted manner.

Additional details on media submission, management or distribution can be found in U.S. Patent Publication 2004/0254883 A1; U.S. Patent Publication 2007/0266028 A1; and U.S. Patent Publication 2007/0266047 A1, each of which is hereby incorporated by reference herein.

Although the embodiments disclosed above focus on offering online customer support in response to a user-request for customer support, the invention can also be implemented so that it automatically offers customer support options in cases where an error message would typically be presented. Thus, when a user encounters a problem while using a program running on his computer or a service on a website, the user can receive context-sensitive help based on what service or program the user was interacting with when the problem arose and/or the level of customer service that particular user is entitled to receive. For example, if a user encounters a server error message or a form validation exception, a context-sensitive help page or contact form can be presented to the user.

The various aspects, features, embodiments or implementations of the invention described above can be used alone or in various combinations.

The invention is preferably implemented by software, hardware, or a combination of hardware and software. The invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer implemented method for presenting context-sensitive help, said method comprising:
providing online service support;
detecting a help request from a particular user; and
presenting help information to the particular user based on the particular user's answers to an ordered series of a predetermined questions.

2. A computer-implemented method of claim 1,
wherein at least one of the predetermined questions is a Frequently Asked Question, and
wherein said presenting of the help information comprises presenting at least an answer to the Frequently Asked Question.

3. A computer-implemented method of claim 1, wherein said presenting of the help information comprises presenting at least a help request form.

4. A computer-implemented method of claim 3, wherein the help request form contains at least a plurality of text fields, at least one of which is pre-populated using information specific to the particular user.

5. A computer-implemented method of claim 4, wherein the information specific to the particular user is obtained by accessing a user-profile associated with the particular user.

6. A computer-implemented method of claim 5, wherein the help information presented to the particular user is limited dependent on information contained in the user-profile associated with the particular user.

7. A computer-implemented method of claim 6, wherein the predetermined questions and the help information are retrieved from a help database.

8. A computer-implemented method of claim 3,
wherein the help request form is filled out by the particular user and submitted to a customer support system, and
wherein the help request form submitted to the customer support system includes at least the help session log, data from the help request form filled out by the particular user, and information obtained from the user-profile associated with the particular user.

9. A computer-implemented method of claim 3,
wherein the help request form is filled out by the particular user and submitted to a customer support system,
wherein the help request form submitted to the customer support system, and
wherein the submitted help request is directed to one or more responders.

10. A computer-implemented method of claim 1, wherein the help information presented to the particular user is dependent on information contained in a user-profile associated with the particular user.

11. A computer-implemented method of claim 1, wherein a help session log is maintained for the help request, and wherein at least a portion of the help session log is used to determine the help information to be presented to the particular user.

12. A computer-implemented method of claim 1, wherein said presenting of the help information comprises presenting at least a help request form, and wherein the help request form is also retrieved from the help database.

13. A computer-implemented method for presenting context-sensitive help, said method comprising:
(a) presenting a user log-in prompt at an online service site;
(b) detecting a user log-in at the online service site by a particular user;
(c) retrieving a user-profile associated with the particular user;
(d) detecting a help request from the particular user; and
(e) presenting context-sensitive help information to the particular user based on the context of the help request and the user-profile.

14. A computer-implemented method as recited in claim 13, wherein the user-profile includes access rights information for the particular user, the access rights information pertaining to certain services available at the online service site, and
wherein said presenting (e) of the context-sensitive help information limits the context-sensitive help information to the particular user based on the access rights information for the particular user.

15. A computer-implemented method as recited in claim 13, wherein the user-profile includes a user classification for the particular user.

16. A computer-implemented method as recited in claim 13, wherein said presenting (e) of the context-sensitive help information limits the context-sensitive help information based on the user classification for the particular user.

17. A computer-implemented method as recited in claim 13, wherein the user-profile includes contractual agreement information for the particular user, the access rights information pertaining to certain services available at the online service site, and wherein said presenting (e) of the context-sensitive help information limits the context-sensitive help information based on the contractual agreement information for the particular user.

18. A computer-implemented method as recited in claim 13, wherein the online service site permits users to submit and manage digital media assets for distribution on an online store, and wherein the context-sensitive help information pertains to submission or management of digital media assets with the online service site.

19. A system for providing context-sensitive help information to a particular authorized user, comprising:
an online server providing an one or more services;
a user-authentication server for the online service provider, the user-authentication server being configured to authorize users;
a user database containing one or more user profiles, the user-database containing user profiles associated with the users of the online service provider, and the user-profiles associated with the users containing information regarding which of the one or more services provided by the online service provider are accessible to the respective users;
a help database comprising help information related to the one or more services provided by the online service provider; and
a help system configured to retrieve help information from the help database in response to a help request from a particular user for help, and to present the retrieved help information to the particular user,
wherein the retrieved help information provided in response to the help request from the particular user is based on the one or more services accessible to the particular user.

20. A system of claim 19, wherein the help database comprises layout information that is used to format the help information presented to the particular user.

21. A system of claim 19, wherein the help database comprises ordered sets of Frequently Asked Questions (FAQs).

22. A system of claim 19, wherein the particular user is presented with an ordered series of predetermined questions, and wherein the help information that is presented to the particular user is presented in response to the particular user's answers to the ordered series of predetermined questions.

23. A system of claim 22, wherein the ordered series of predetermined questions are retrieved from the help database.

24. A system of claim 23, wherein the layout of the ordered series of predetermined questions that are presented to the particular user is retrieved from the help database.

25. A system of claim 23, wherein at least one of the series of questions that is retrieved from the help database is presented in the form of a question and a set of answers selected from a pop-up menu.

26. A system of claim 25, wherein when the user selects a particular answer from the set of answers in the pop-up menu, another help request is initiated and responsive help information is subsequently presented, whereby the help information is dynamically updated.

27. A computer implemented method for providing context-sensitive help information to a particular authorized user, comprising:
presenting, at a computing device, one or more modules;
authenticating a particular user for use of the one or more modules;
receiving a help request for help information from the particular user;
retrieving a user profile for the particular user from a user-database containing one or more user profiles, the user-profile associated with the particular user containing information regarding which of the one or more modules are available to the particular user;
determining the one or more modules that are available to the particular user based on the user profile;
retrieving help information related to the one or more modules based on the determined one or more modules available to the particular user; and
presenting the help information to the particular user in response to the help request from the particular user,
wherein the help information presented to the particular user is limited to help information that pertains to one or more of the one or more modules that are available to the particular user.

28. A computer implemented method of claim 27, wherein the particular user is presented with a series of questions, and wherein the help information that is presented to the particular user is presented in response to the particular user's answers to the series of questions.

29. A computer implemented method of claim 28, wherein at least one of the questions that is retrieved from the help database is presented in the form of a question and a set of answers selected from a pop-up menu.

30. A system of claim 29, wherein said method further comprises:
selecting an answer from the set of answers in the pop-up menu causes the help information to be dynamically updated.

31. A computer implemented method claim 27, wherein layout information is retrieved from a help database and used to format the help information presented to the particular user.

32. A computer implemented method of claim 31, wherein the layout of the series of questions that are presented to the particular user is determined by the layout information.
